(19) United States
(12) Patent Application Publication
(10) Pub. No.: US 2003/0141375 A1
(43) Pub. Date: Jul. 31, 2003

(54) Information bearing marking used with a digitally watermarked background

(75) Inventor: Nabil M. Lawandy, North Kingstown, RI (US)

Correspondence Address: HARRINGTON & SMITH, LLP, 4 RESEARCH DRIVE, SHELTON, CT, 06484-6212, US

(73) Assignee: Spectra Systems Corporation

(21) Appl. No.: 10/353,447

(22) Filed: Jan. 29, 2003

Related U.S. Application Data
(63) Continuation-in-part of application No. 09/801,445, filed on Mar. 8, 2001.
(60) Provisional application No. 60/188,036, filed on Mar. 9, 2000.
(60) Provisional application No. 60/222,079, filed on Aug. 1, 2000.

(51) Int. Cl. G06K 19/06

(52) U.S. Cl. 235/494

(57) ABSTRACT

A method and apparatus for enhancing encoded information through the addition of a digitally watermarked background is disclosed. The digitally watermarked background may incorporate semantic information derived from an object or further supplemental information to produce a digitally watermarked background for the encoded information. The digitally watermarked background may modify, replace, or be used in conjunction with the content of the encoded information. The digitally watermarked background may be used as a key to limit access to the information in the encoded information.

### CLAIM OF PRIORITY FROM COPENDING APPLICATION

This patent application is a Continuation-In-Part of and claims priority from co-pending U.S. patent application Ser. No. 09/801,445 filed Mar. 8, 2001; which in turn claims priority from U.S. Provisional Application Serial No. 60/188,036, filed Mar. 9, 2000, entitled “Authentication by Size, Shape, and Fluorescence,” Attorney Docket No. 902.0010USP, by Nabil M. Lawandy, and from U.S. Provisional Application Serial No. 60/222,079, filed Aug. 1, 2000, entitled “Digitally Watermarked Bar Codes,” Attorney Docket No. 902.0015USP, by Nabil M. Lawandy. The disclosures of these applications are incorporated by reference herein.

### FIELD OF THE INVENTION

This invention relates to a method and apparatus for providing reliable and repeatable identification and authentication of an object by using a digital watermark.

### BACKGROUND OF THE INVENTION

Bar codes and other information bearing markings bearing encoded information are virtually ubiquitous. Consider the marking of goods such as foodstuffs in the stream of commerce. These products are frequently labeled with a “UPC” code. The code typically carries information that is used to associate the foodstuff with certain characteristics, such as price. Some of the existing marking schemes, however, only provide limited information. For example, UPC codes do not typically carry additional information, such as expiration date. As some of these coding systems are so common, the expense of moving to a new coding system is accordingly high, and therefore unattractive to many users. Therefore, what is needed is a technique to augment commonly used coding systems.

Another aspect of the exemplary use of a code for the marking of foodstuff is the aesthetic of the packaging. It is well known that many manufacturers use packaging for advertising of their product. Therefore, from the manufacturer's point of view, any additional markings added to such products should not detract from the packaging.

In further applications, it is frequently considered advantageous to use secure markings. For example, secure markings are useful to the garment industry where counterfeiting is a known problem. For example, bar codes alone may not provide adequate assurance of authenticity, as they may be easily copied. Therefore, what is needed is a system that can provide for verification of authenticity.

A known security device for verifying an item's authenticity is a watermark. Watermarks or signatures are typically produced by utilizing semantic information of the item to be protected, for example, alphanumeric characters, physical features, etc. or other related information (e.g. ownership information). These signatures or watermarks are typically kept with, or incorporated into, the protected item. For example, a watermark may be printed within or onto the substrate of a negotiable instrument. In this case, the watermark may typically include information regarding the value and the originator of the instrument. Various digital watermarking techniques are known for both still and video images. Reference in this regard may be had to Hartung et al., “Digital Watermarking of Raw and Compressed Video”, Systems for Video Communication, October 1996, pp. 205-213 and Hartung et al., “Watermarking of MPEG-2 Encoded Video Without Decoding and Re-encoding”, Proceedings of SPIE 3020, Multimedia Computing and Networking 97 (MMCN 97), February 1997.

Some of the techniques discussed in these papers include separately coding the image and a watermark image using a pseudo random number generator and a discrete cosine transform (DCT) to form coded blocks, one of the image to be watermarked and the other of the watermark itself. The DCT coefficients representing the coded watermark block and the coded image block are then added together to form a combined block thus digitally watermarking the image.

Reference may also be had to U.S. Pat. No. 6,037,984, entitled “Method and Apparatus for Embedding a Watermark into a Digital Image or Image Sequence,” by Isnardi et al., issued Mar. 14, 2000. This patent discloses watermarking an image or sequence of images using a DCT unit and quantizer. The patent discloses generating an array of quantized DCT coefficients and watermarking the array by selecting certain ones of the DCT coefficients and replacing them with zero values. The masked array is further processed by a watermark inserter that replaces the zero valued coefficients with predefined watermark coefficients to form a watermarked array of DCT coefficients, that is, a watermarked image.

It is also well known that valuable items, for example, negotiable instruments, art work, etc. are susceptible to theft and counterfeiting. With regard to documents, the advancement of color copier technology has made it fairly easy to create a color copy of any document, including currency, using commonly available equipment. The use of digital watermarks to protect such items is also known.

Reference may be had to U.S. Pat. No. 6,343,138 B1 “Security Documents with Hidden Digital Data” issued Jan. 29, 2002 by Rhoads. This patent discloses use of an identification code signal hidden in a carrier signal, later to be discerned. Similary, U.S. Pat. No. 6,243,480 “Digital Authentication with Analog Documents” issued Jun. 5, 2001 by Zhao et al., discloses techniques for protecting the security of digital representations, and analog forms made from them.

Therefore, what is needed is a technique to provide supplemental information for an information bearing marking which is optimally unobtrusive and secure.

### SUMMARY OF THE INVENTION

The foregoing and other problems are overcome by methods and apparatus in accordance with embodiments of this invention.

Disclosed herein is a marking scheme that includes the use of a digitally watermarked background in conjunction with encoded information in the form of a code, such as a bar code. The digitally watermarked background, which may have low contrast, high contrast or a varying degree of contrast, contains features that provide variation in the spectral content and/or spatial content. The digitally watermarked background may be applied before or after the application of the encoded information, or may be created simultaneously with the encoded information. The digitally watermarked background and/or the encoded information may be applied by use of an intermediate transfer device, such as a label. The digitally watermarked background may present additional encoded information that may be used to supplement, modify, or replace the coexisting encoded information.

The digitally watermarked background may include information describing or related to the object to which it is applied. The information may be used as at least one input for deriving a key to decode information that is stored in the digitally watermarked background or the encoded information, and may further provide for authentication of the object.

### BRIEF DESCRIPTION OF THE DRAWINGS

The above set forth and other features of the invention are made more apparent in the ensuing Detailed Description of the Invention when read in conjunction with the attached Drawings, wherein:

FIGS. 1A-1C, collectively referred to as FIG. 1, illustrate a bar code and a digitally watermarked background;

FIG. 2 is an illustration of a bar code affixed to an object, with a separate label having a digitally watermarked background;

FIG. 3 is an illustration of an embodiment of a marking where the digitally watermarked background surrounds a portion of the bar code;

FIG. 4 is an illustration of a multi-layer bar code and a digitally watermarked background;

FIG. 5 is an illustration of a detection system for detecting and decoding the digitally watermarked background;

FIG. 6 is a block diagram showing the major sub-components of an exemplary hand-held, portable, apparatus for detecting and decoding markings that include a bar code and a digitally watermarked background;

FIG. 7 is an elevational view of the apparatus of FIG. 6; and,

FIG. 8 is a simplified block diagram of the exemplary hand-held, portable apparatus having a wireless link to a remote data processor.

### DETAILED DESCRIPTION OF THE INVENTION

Disclosed herein is a marking system that includes the use of a digitally watermarked background in conjunction with another marking scheme. The marking system disclosed herein may be used in a variety of applications such as in support of identification and authentication schemes.

An exemplary application involves use of the digitally watermarked background in cooperation with a bar code. The digitally watermarked background may be used for authentication of the bar code or associated goods.

A marking is produced using a coding scheme, such as a bar coding scheme, and a digitally watermarked background. A “marking” or “composite marking” includes, in this case, a digitally watermarked background component and a bar code component. These components are considered “coexisting” as one overlies or appears as a background to the other.

In some embodiments, one component of the coexisting information is read in conjunction with the other component. In other embodiments, one component may replace or supersede the other component. In other embodiments, the two components are read separately, as each conveys different and/or unrelated information.

As used herein, the term “code” is synonymous with “bar code” and is to be construed as indicia derived from any marking scheme suited to marking a specific article or object with encoded information. It is anticipated that a large variety of marking schemes beyond those commonly referred to as “bar codes” may be used for practice of this invention. However, as bar codes are well known and may be used for various embodiments of this invention, the disclosure makes non-limiting reference to a code as a “bar code.”

Aside from those coding formats generally considered to be “bar codes,” or of a class known as such, codes may include, without limitation, geometric symbols, alphanumeric text, graphical patterns, images or combinations thereof. In certain embodiments, the code is suitable for decoding with optical character recognition techniques. In general, any representation of data deemed acceptable to the user may be used. For convenience, each element of the broad array of data representations is herein referred to as either a “code” or a “bar code” without limitation to or exclusion of a specific embodiment of code.

In various embodiments, the digitally watermarked background features low contrast, high contrast, or varying degrees of contrast with the coexisting bar code. In some embodiments the digitally watermarked background may include at least one texture, the appearance of a texture, or at least one color. Control of such aspects, and others as may be devised or known and used, provide for physical aspects of a digital watermark. For example, variation in the spectral content (frequency domain) or the spatial domain may be used for encoding of information.

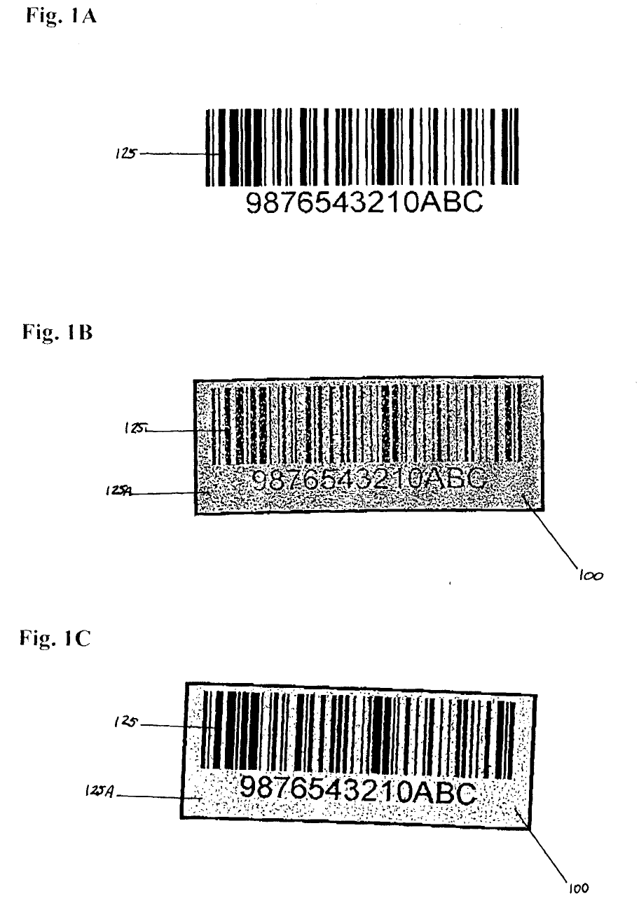

Selected input information (e.g., information described herein as “semantic” or “supplementary” information) is used to produce a “digest.” The digest is incorporated into the digitally watermarked background in a manner that provides for a complete record of the input information which does not otherwise perturb characteristics of the digitally watermarked background. An example of a digitally watermarked background, used in concert with a bar code, is provided in FIG. 1.

FIGS. 1A-1C, collectively referred to as FIG. 1, provide an illustration of embodiments of bar code 125. In FIG. 1A, a bar code 125 appears over a plain background in a conventional manner. FIG. 1B illustrates the same bar code 125, where the bar code 125 is coexisting with a digitally watermarked background 125A, thus forming a marking 100. In FIG. 1C, the variation in the coexisting digitally watermarked background 125A in the marking 100 is characterized by a lower frequency than that of FIG. 1B.

As an example of the manipulation of an aspect of the digitally watermarked background 125A, in one embodiment the frequency domain is adjusted for control of copying. For example, the presence of the digital watermark may dominate to the extent that making copies of the bar code 125 is inhibited, or the bar code 125 is affected by the presence of the digitally watermarked background 125A to the extent that it is no longer legible. In other embodiments, the appearance of the digitally watermarked background 125A may be imperceptible to an unaided observer.

In some embodiments, “semantic information” (i.e., the information describing or derived from characteristics of an object) is used as at least one input into the digital watermarking scheme. Semantic information may include information derived from any one or more of a variety of sources. For example, physical attributes of the object may be considered. Such attributes may include, without limitation, size, weight, a dimension (or dimensions), color(s), magnetic properties and others. Semantic information may include or account for content or other aspects of text appearing on the object. Additionally, semantic information may be derived indirectly from the object. For example, semantic information may be derived from a combination of a dimension and weight through use of an algorithm.

Additional features, such as taggants or other security features incorporated into or onto the object may be a source of semantic information. Aspects of such additional features as taggants may be incorporated into the digitally watermarked background 125A, or otherwise appear in association with the object. Examples of semantic information that may be associated with taggants include, without limitation, population density, colors present, size, shape, emission wavelength. Such techniques and features are described in U.S. patent application Ser. No. 09/801,445 filed Mar. 8, 2001, and herein incorporated by reference in its entirety.

The digitally watermarked background 125A may contain a variety of content referred to herein as “supplementary” information. For example, the digitally watermarked background 125A may contain as supplementary information tracking information, brand information, date of manufacture, date of expiration, lot number, country of origin, an authorized distribution channel and/or any other information deemed relevant by the user. In some embodiments, the supplementary information may entirely replace, supersede or invalidate other coexisting information, such as the information encoded within the bar code 125.

In further embodiments, both semantic and supplementary information may be used as inputs to the digital watermarking algorithm.

Once marked, an object may subsequently be authenticated by use of the marking 100. Subsequent authentication procedures involve ascertaining appropriate information, such as and not limited to, semantic or supplementary information. Once ascertained, the authentication information is used as an input for the formation of a new digest. Aspects of the new digest are then compared to aspects of the digest recorded in the digitally watermarked background 125A. The object is thereby authenticated when aspects of the new digest are within acceptable tolerances of agreement with the previously recorded information.

Further techniques for making use of and incorporating digital watermark information are known, and described in U.S. Pat. No. 6,243,480 B1, the disclosure of which is herein incorporated by reference in its entirety.

The marking 100 may be realized in a variety of embodiments. For example, in some embodiments, the digitally watermarked background 125A is printed simultaneously with the bar code 125. In some other embodiments, the digitally watermarked background 125A is applied to a substrate first, and marking with the bar code 125 occurs subsequently. In further embodiments, the digitally watermarked background 125A is applied after the bar code 125, such as by printing over the bar code 125, or by applying a label over the bar code 125.

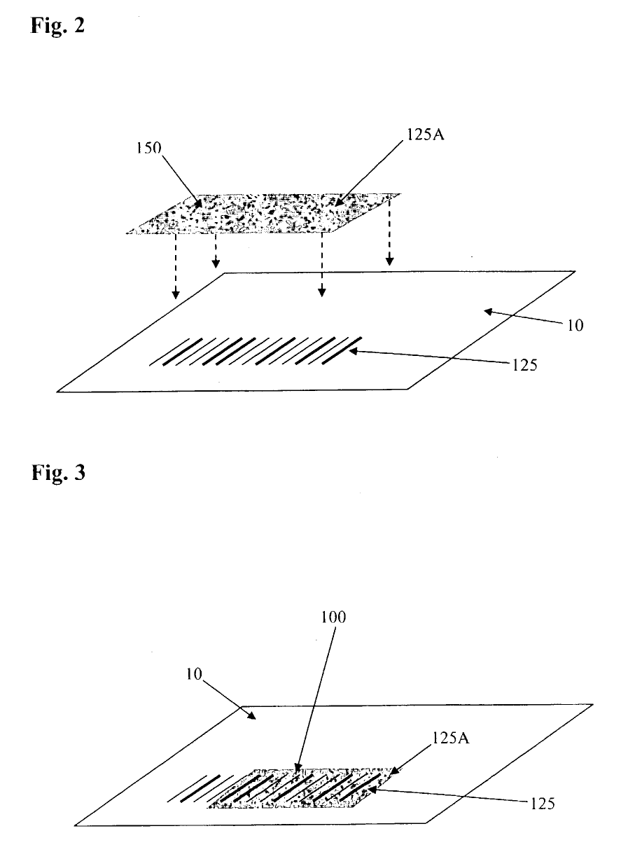

FIG. 2 provides an illustration of an embodiment where the digitally watermarked background 125A is applied over a bar code 125 in the form of a label 150. The marking is created by the joining of the digitally watermarked background 125A and the bar code 125 is affixed to the surface of an object 10. The dashed downward arrows in FIG. 2 illustrate the label 150 being applied directly over the bar code 125.

FIG. 3 provides an illustration of a further embodiment. In this embodiment, the digitally watermarked background 125A surrounds only a portion of the bar code 125 to form a marking 100. In this embodiment, the digitally watermarked background 125A is also considered “coexisting” although a portion of the bar code 125 does not have a digitally watermarked background 125A. In other embodiments, the digitally watermarked background 125A is coexisting although it appears only within the pattern of the bar code (i.e. between the bars of the bar code). Therefore, where the digitally watermarked background 125A is practiced in conjunction with a bar code 125 so as to form a marking 100, the digitally watermarked background 125A and the bar code 125 are considered “coexisting.”

In embodiments where a label 150 is employed, the label 150 is formed of materials that are at least one of non-transmissive, partially transmissive, transmissive, substantially or highly transmissive at wavelengths of interest. Wavelengths of interest may include wavelengths such as visible light, or other wavelengths, such as readout wavelengths for the label or a coexisting bar code. The label 150 may be attached using an adhesive backing or through other techniques.

Labels 150 may contain specific encoded information (e.g., semantic information where a dimension taken from the object), or generally repeating encoded information (e.g., supplemental information where a lot number is to be included). In some embodiments, repeating encoded information bearing labels 150 may be dispensed in rolls, or other ways known for dispensing labels 150. Preferably, the digital watermarked background 125A is robust to copying or other duplication techniques, and remains functional in second or third generation copies. Labels 150 may carry either one of or both of the digitally watermarked background 125A and the bar code 125.

In some embodiments, a substantially transmissive label 150 is used to apply the second component of the marking 100 over the first. For example, in one embodiment, a bar code 125 is recorded onto a label 150, and subsequently applied over a digitally watermarked background 125A. In this embodiment, the label 150 does not obscure the underlying digitally watermarked background 125A. In other embodiments, a non-transmissive label 150 carrying both the bar code 125 and the digitally watermarked background 125A is applied over an existing marking on a substrate 10. One can quickly determine that many combinations may be realized, where each one may offer certain advantages over another. It should therefore be clear that varying aspects, such as and not limited to, the order of application of the bar code 125, the digitally watermarked background 125A and the transmissivity of a label 150 can provide for many more embodiments than those described herein. Other non-limiting examples of aspects that may be varied include emission wavelengths and form of the label 150.

Although referred to as a “label 150,” this term is considered generic and non-limiting. For example, in other embodiments, a barcode 125 is applied over a digitally watermarked background 125A or vice versa by the use of shrink wrapping. In these embodiments, the shrink wrapping serves another purpose, namely as a packaging component. Therefore, labels 150, like shrink wrapping and its equivalents, are considered to be “intermediate transfer devices 150” and synonymous as used herein. The term “intermediate transfer device” therefore relates to the use of these items, and other suitable equivalents, to conveniently retain a digitally watermarked background 125A for subsequent application over a bar code 125 (or vice versa). One may envision that other intermediate transfer devices 150 may be devised. For example, a digitally watermarked background 125A could be incorporated into a transmissive plastic case, or over-pack, (e.g. in the case of optical media) where the digitally watermarked background 125A overlies a bar code 125 affixed to the contents (e.g. an optical media).

Manifestations or applications of the code 125 may be realized in any manner that is deemed suitable, including without limitation, printing, silk screening, embossing, etching, engraving, spraying, painting or use of an intermediate transfer device. Likewise, the digitally watermarked background 125A may be placed onto a substrate in any manner that is deemed suitable, including and without limitation, printing, silk screening, embossing, etching, engraving, spraying, painting, use of an intermediate transfer device 150.

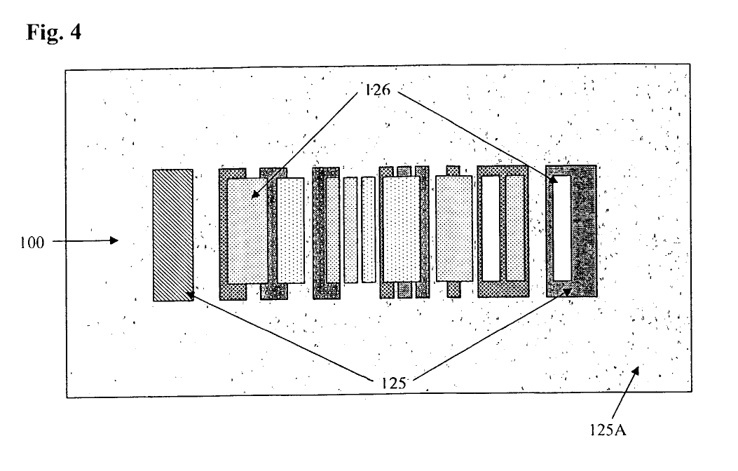

In some embodiments, multiple layers of bar codes 125 may be employed. That is, as shown in FIG. 4, consider an example where a first bar code 125 is formed of ink that fluoresces only in the UV region. The ink is transparent, or substantially transparent in the visible, near infrared, or infrared region. A second bar code 126 is formed of ink that appears only in the infrared region. In this example, the first bar code 125 and the second bar code 126 are imaged and decoded without substantial interference from each other, thereby providing for display or retention of additional information. That is, the wavelength for readout of the first bar code 125 is substantially separate from or non-interfering with the wavelength for readout of the second bar code 126. Likewise, in other embodiments, the wavelength for readout of the first bar code 125 may be substantially separate from or non-interfering with the wavelength for readout of the digitally watermarked background 125A. In other embodiments, the digitally watermarked background 125A and/or the bar code 125 appear when illuminated with wavelengths of visible light, and may be readily observed under typical ambient lighting.

In other embodiments, the digitally watermarked background 125A may be imaged and decoded without regard for the presence of the bar code 125 as the digitally watermarked background 125A appears at wavelengths that are distinct from the bar code 125. In further embodiments, the bar code 125 is obscured by an overlying digitally watermarked background 125A. In some of the further embodiments, the digitally watermarked background 125A is used, as a supplement, or as a replacement to the co-existing bar code 125. The marking of perishable items provides an exemplary embodiment of the use of the combination of the digitally watermarked background 125A and a bar code 125.

In one embodiment where the combination is used to mark perishable items, the bar code 125 contains typical product codes used to associate a price with an item. The digitally watermarked background 125A is used as an enhancement to the product code, where the digitally watermarked background 125A contains information, such as an expiration date. Thus, the manufacturer is provided with an ability to individually and discreetly label perishable items in an otherwise standard package, thus realizing a savings on packaging expenses, without compromising package appearance and without involving additional steps, such as embossing of a date code.

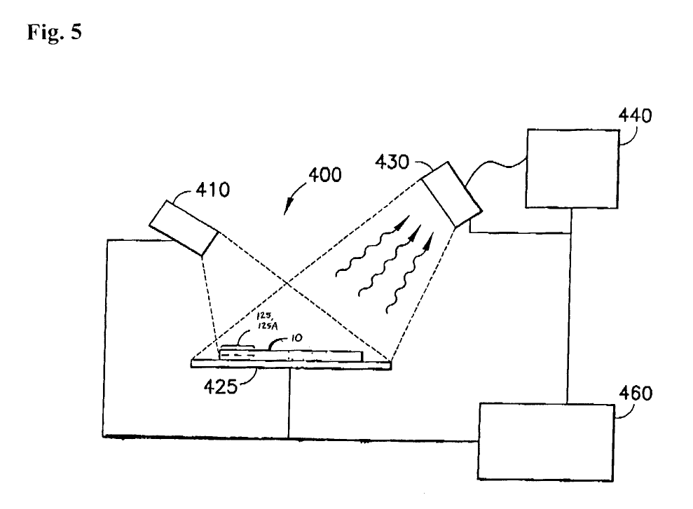

In various embodiments, the digitally watermarked background 125A does not interfere with the normal reading of the bar code 125. That is, the digitally watermarked background 125A is at least partially and preferably substantially, transmissive at the wavelengths used for readout of the bar code 125. Furthermore, in embodiments such as where the invention is used for inventory control of perishable goods 10, an appropriate detection system for decoding the digitally watermarked background 125A, such as the one described below in relation to FIG. 5, may be used for taking inventory of the product 10. Using an appropriate detection system for the decoding of the digitally watermarked background 125A (and/or bar code 125) the operator is able to make rapid determinations regarding the age, lot number, or other aspect, of the product 10.

In further embodiments of a marking 100, the bar code 125 component or the digitally watermarked background 125A component is decoded to obtain a key to permit access to the remaining component. That is, without the information contained in the first component, the second component cannot be read or interpreted.

A detection system 400 in accordance with the invention is shown in FIG. 5. A source of radiation 410 is directed on an item 10 to be examined. The source 410 may generate any type of radiation that is suitable for detecting the code 125 and/or digitally watermarked background 125A, as well as any appropriate attributes of the item 10. The item 10 may be mounted on a positioning device 425 in order to locate the item 10 for irradiation or illumination by the source 410. The positioning device may include a conveyor or any other type of device suitable for transporting or locating the substrate for irradiation. A detector array 430, such as a CCD, a camera which may be fixed, moveable or handheld, or any suitable detection device, with appropriate support circuitry 440 detects an image of the marking 100 and any semantic or other information as appropriate. The source 410 and detector array 430 may also comprise positioning devices (not shown) for locating these devices for optimum performance. In response to being irradiated or illuminated by the source 410, the item 10 may also emit or reflect one or more wavelengths associated with the marking 100. The detector array 430 may be capable of detecting the spectral content of any emissions of the object 10 and the marking 100. Control circuitry 460 directs the activity of the overall system 400, and in particular controls the source 410, positioning device 425, detector array 430 and support circuitry 440.

Other non-limiting imaging apparatus or techniques which may be employed to detect and decipher the markings 100 are known. For example, techniques such as described in U.S. patent application Ser. No. 09/801,445 filed Mar. 8, 2001 may be employed to detect and decipher the digitally watermarked background 125A.

As another example of an imaging system, a hand-held reader is used to read a marking 100. The hand-held system provides operators with an ability to detect and read markings 100 that are in use at a remote location. That is, the hand-held system, through appropriate communication links, is able to provide operators with an ability to make field determinations regarding information derived from a marking 100, and therefore to provide appropriate updates related to the existing digitally watermarked background 125A. In other embodiments, the hand-held reader operates in a stand alone mode to complete determinations of information contained in the marking 100.

An example of an appropriate handheld detection system is the VERICAM™ of Spectra Systems Corporation of Providence R.I. An appropriate hand held system is now described in more detail.

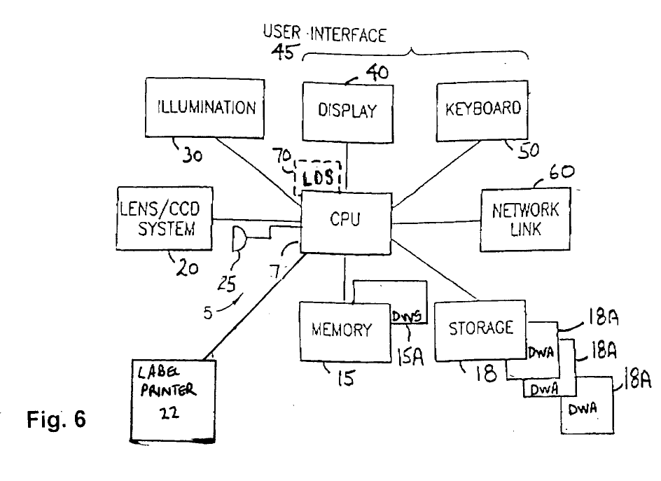

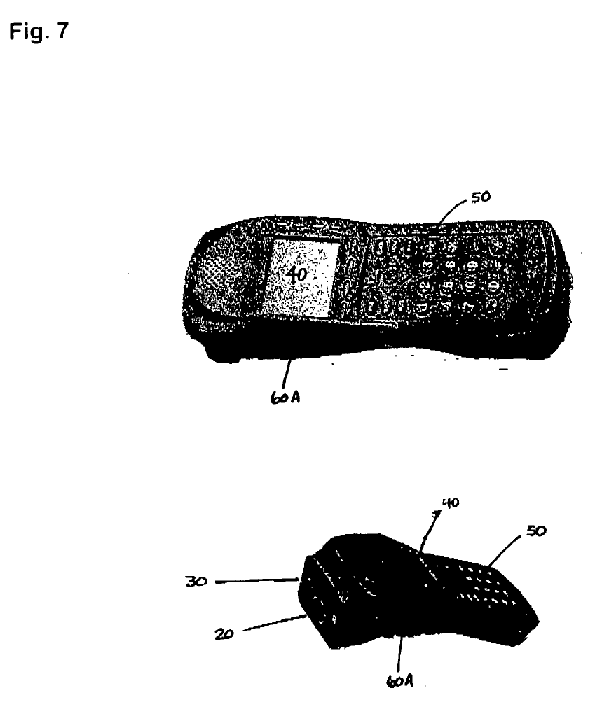

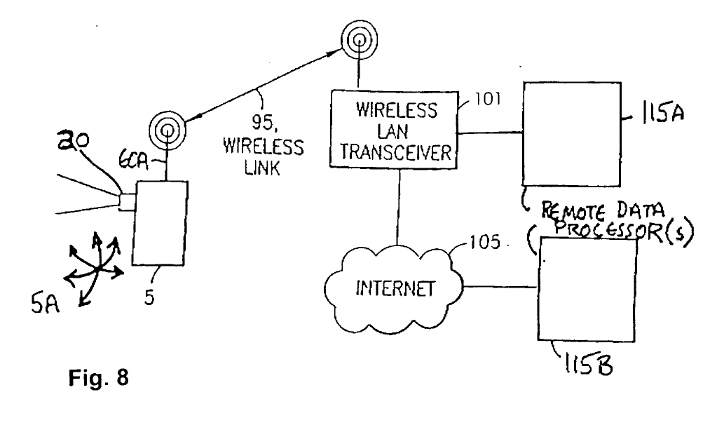

Referring to FIG. 6, FIG. 7 and FIG. 8, the hand-held apparatus for digital watermarking, or device 5 includes a CPU 7, such as an embedded microprocessor, an internal read/write memory 15 and optional, preferably non-volatile mass storage 18. FIG. 6 illustrates that the device 5 also includes a digital camera lens/CCD system 20, at least one illumination source 30 and a user interface 45 with a display (LCD) 40 and a keypad or keyboard 50. The illumination source 30 can be a variable intensity source controlled by an operator, and it can also include a flash source. In some embodiments the illumination source 30 may not be necessary, depending on the ambient illumination conditions.

The lens/CCD system 20 and illumination source 30 can be located on a surface opposite that of the display and keyboard 50, enabling the operator to view the image being captured on the display 40, to manipulate the keys of the keyboard 50, to initiate the operation of the digital watermark software (DWS) 15A stored in the memory 15 or 18, and perform other functions, such as initiating a transfer of data to a remote location via a wireless network link 60 having, for an RF embodiment, an antenna 60A. The lens/CCD system 20 includes a digital camera of adequate resolution (e.g., 1.45 mega pixels or greater), with appropriate support circuitry providing auto-focus and other typically found features. The image capture sub-system works in cooperation with other components of the hand-held system.

An optional microphone 25 can be provided that includes a wireless transceiver. In one embodiment, the device 5 is water proof, or water resistant, and designed for use in humid or wet environments.

The device 5, as shown in FIG. 7, may be battery powered, or powered by an external power supply. The device 5 is preferably sized so that it can be readily manipulated with one hand by the operator, in much the same manner that a digital camera or a wireless communications device can be manipulated by a user.

The device 5 is configured to detect and decipher specialized digital watermarks, such as those encoded with invisible ink, and appearing at predetermined wavelengths. For example, the device may be configured to recognize digitally watermarked fluorescent images that appear only at ultraviolet and/or infrared wavelengths, or the device 5 may simply image and decode digital watermarked information under ambient illumination.

Some type of location determining system (LDS) 70 may be provided within the device 5, such as one based on the Global Positioning System (GPS). In another embodiment, the LDS 70 is connected to the device 5 through a communication port, or other appropriate means. In this case, the location information can be transferred to the remote data processor(s) 115, as shown in FIG. 8.

The device 5, through operation of digital watermark software (DWS) 15A, decodes a digitally watermarked background 125A using one or more digital watermarking algorithms (DWAs) 18A, which are based upon information encoding schemes used to create the digitally watermarked background 125A. The device 5 may execute the DWS 15A either alone or in cooperation with one or more remote data processors 115.

The digital watermark software (DWS) 15A presents users with options to load a particular DWA 18A. The DWS 15A the appropriately controls or implements features of the hand-held device 5 (such as the CCD array 20, and illumination 30), and provides appropriate inputs to the selected DWA 18A to obtain desired output. In this manner, the device 5 may appropriately evaluate a digitally watermarked background 125A for information contained in the digest produced by any one (or more) of a number of information encoding schemes.

The network links 60, 60A, 95 provide users with an ability to move data from volatile storage (memory 15) or non-volatile storage (storage 18). Users may therefore communicate with external systems to update DWAs 18A, send or receive images, update software and perform other similar operations. The device 5 may be enabled for remote operation through the network links 60, 60A, 95.

Data may be stored in any structure determined appropriate by the user. For example, an image of a marking 100 may be produced and stored in memory 15, or in the non-volatile storage 18. Alternatively, a user may prefer to retain additional associated information. For example, a user may wish to retain a data set for each image that includes the digital data representing the original marking 100, the input information, such as the date, time and location, output of the DWA 18A. Further embodiments include storage of information associated with or related to semantic or supplemental information. The actual structure and content of the data retained is therefore flexible, and is limited by user need, and device 5 characteristics, such as available memory 15.

In an exemplary embodiment, a data processor 115 is associated with a law enforcement agency. In this embodiment, the device 5 is used by a law enforcement agency for collecting of immigration data by observation of passports and encoded information thereon. In this example, the digitally watermarked background 125A may include information such as, but not limited to, time, date and location. The device 5 may therefore be used to rapidly ascertain information otherwise not available to one inspecting the document.

In further versions of this embodiment, the device 5 then communicates information to the remote data processor 115 which sends instructions to a digitally watermarked background 125A production device (e.g. a label printer) which is located at the facility where the device 5 is in use. In response, an updated digitally watermarked background 125A is produced for applying over a coding 125 present on a passport.

As a second exemplary embodiment, the digitally watermarked background 125A provides supplemental information to a bar coded product contained in an expansive warehouse. In this embodiment, the digitally watermarked background 125A contains considerable information in comparison to the information contained in the bar code 125, and would not lend itself to encoding in a bar code 125. In this exemplary embodiment, it is important for a user to make rapid determinations of the supplemental information, and therefore convenient to obtain translation of the information on the spot.

In the second exemplary embodiment, the device 5 is then used in a stand-alone fashion to detect and interpret the supplemental information, thereby informing the user of the supplemental information without requiring a connection to a remote data processor 115, such as an inventory management data processor. In further embodiments, a label printer 22 is carried with the device 5, and generates a digitally watermarked background 125A, or updates to a digitally watermarked background 125A on the spot.

One example of an application of the second exemplary embodiment involves the sorting, labeling and maintenance of various types of waste in a large industrial waste storage facility. In this example, users may consider it advantageous to quickly obtain a significant quantity of supplemental information regarding a specific object (e.g., when containers lose integrity). For example, a user may wish to know the contents of a large box of waste, related health and safety information, generation and disposition information, and other similar information. The user may wish to print a label 150 to augment the existing marking 100, whereby the encoded information in the digitally watermarked background 125A of the label 150 contains information related to a survey of the integrity of the large box, user name and date taken. Use of a digitally watermarked background 125A can thus provide users with an ability to ascertain or update important information, while using a marking scheme that is relatively benign in light of production needs.

It can be appreciated that the techniques and structures described above are useful for marking and/or authenticating substrate objects based on coding mechanisms and watermarks included in or applied to the object. It can also be appreciated that the disclosure herein provides for a great number of embodiments and uses for the marking system disclosed herein. Therefore, it should be understood that the embodiments disclosed are illustrative and not limiting

It can thus be appreciated that while the invention has been particularly shown and described with respect to preferred embodiments thereof, it will be understood by those skilled in the art that changes in form and details may be made therein without departing from the scope and spirit of the invention.

What is claimed is:

1. A method for marking an object, comprising:
producing a digitally watermarked image; and,
applying the digitally watermarked image onto the object so as to be coexisting with a code, thereby forming a digitally watermarked background image.

2. The method of claim 1, further comprising:
ascertaining semantic information from the object;
incorporating the semantic information into the digitally watermarked background.

3. The method of claim 2, wherein the semantic information comprises at least one of a dimension, weight, color and magnetic properties.

4. The method of claim 2, wherein the semantic information comprises at least one of a population density of taggants and emission wavelength of taggants.

5. The method of claim 1, wherein the digitally watermarked background comprises supplementary information comprising at least one of tracking information, brand information, a date of manufacture, date of expiration, lot number, a country of origin, and an authorized distribution channel.

6. The method of claim 1, wherein at least one of the marking and the digitally watermarked background are applied to the object by an intermediate transfer device.

7. The method of claim 6, wherein the intermediate transfer device comprises an adhesive backing.

8. The method of claim 6, wherein the intermediate transfer device comprises at least one of a label, a shrink wrap and an over-pack.

9. The method of claim 6, wherein the intermediate transfer device at wavelengths of interest is at least one of non-transmissive, transmissive, substantially transmissive and highly transmissive.

10. The method of claim 1, wherein applying comprises at least one of printing, silk screening, embossing, etching, engraving, spraying and painting.

11. The method of claim 1, wherein producing comprises controlling at least one the spatial domain and the spectral domain.

12. The method of claim 1, wherein a wavelength for readout of the code is substantially separate from a wavelength for readout of the digitally watermarked background.

13. The method of claim 1, further comprising:
applying a second code over the digitally watermarked background.

14. The method of claim 1, further comprising the steps of:
detecting the digitally watermarked background;
decoding the digital watermark to obtain information included therein;
authenticating the object by comparing the information included in the digitally watermarked background to authentication information.

15. The method of claim 14, wherein the authentication information comprises at least one of semantic information and supplemental information.

16. A marking for identifying an object, comprising:
a digitally watermarked background adapted for use with a code, a manifestation of the code coexisting with the digitally watermarked background upon the object.

17. The marking of claim 16, wherein the digitally watermarked background comprises at least one of semantic information and supplemental information.

18. The marking of claim 17, wherein the semantic information comprises at least one of a dimension, weight, color and magnetic properties.

19. The marking of claim 17, wherein the semantic information comprises at least one of a population density of taggants and emission wavelength of taggants.

20. The marking of claim 16, wherein the supplemental information comprises at least one of tracking information, brand information, date of manufacture, date of expiration, lot number, a country of origin, and an authorized distribution channel.

21. The marking of claim 16, wherein the digitally watermarked background comprises a key to readout of the code.

22. A method for modifying a code used for marking an object, comprising the steps of:
providing an intermediate transfer device adapted for carrying a digitally watermarked background;
applying a digitally watermarked background to the intermediate transfer device;
applying the intermediate transfer device to the object so as the digitally watermarked background is coexisting with the code.

23. The method of claim 22, further comprising:
ascertaining semantic information from the object; and,
incorporating the semantic information into the digitally watermarked background.

24. The method of claim 22, wherein said intermediate transfer device at wavelengths of interest is at least one of non-transmissive, partially transmissive, transmissive, substantially transmissive and highly transmissive.

25. The method of claim 22, wherein the digitally watermarked background comprises supplementary information comprising at least one of tracking information, brand information, a date of manufacture, date of expiration, lot number, a country of origin, and an authorized distribution channel.

26. The method of claim 22, wherein the digitally watermarked background comprises a key to readout of the code.

27. The method of claim 22, wherein applying comprises controlling at least one the spatial domain and the spectral domain.

28. The method of claim 22, wherein the intermediate transfer device comprises at least one of a label, a shrink wrapping and an over-pack.

29. An apparatus for reading a digitally watermarked background, the apparatus comprising:
a portable device comprising at least a digital camera, memory and a microprocessor; and at least one digital watermarking algorithm stored in the memory, the algorithm adapted for decoding of at least one digital watermark in an image comprising a digitally watermarked background to a coexisting code.

30. A method for reading a digitally watermarked background, the method comprising:
providing a portable device comprising at least a digital camera, memory and a microprocessor; and at least one digital watermarking algorithm stored in the memory, the algorithm adapted for decoding of at least one digital watermark in an image comprising a digitally watermarked background to a coexisting code;
collecting an image of a code with a coexisting digitally watermarked background; and,
decoding information contained in the digitally watermarked background.
